(19) United States
(12) Patent Application Publication
(10) Pub. No.: US 2020/0378433 A1
(43) Pub. Date: Dec. 3, 2020

(54) DRIVE SHAFT

(71) Applicant: LENTUS COMPOSITES LIMITED, Banbury Oxfordshire (GB)

(72) Inventors: Paul Lewis, Eynsham Oxfordshire (GB); Michael Dewhirst, Eynsham Oxfordshire (GB)

(21) Appl. No.: 16/496,781

(22) PCT Filed: Mar. 20, 2018
(86) PCT No.: PCT/GB2018/050719

§ 371 Date: Sep. 23, 2019

(30) Foreign Application Priority Data
Mar. 28, 2017 (GB) 1704898.4

(51) Int. Cl. F16C 3/02

(52) U.S. Cl. CPC F16C 3/026; F16D 1/0858; F16C 3/023

(57) ABSTRACT

A method of assembly of a drive shaft comprising providing a tubular member 12 of composite material form, fitting a collar 24 of composite material form to an exterior of an end part of the tubular member 12 to inwardly compress the end part of the tubular member 12, and subsequently press fitting part 14a, 16a of an end fitting 14, 16 into the interior of the end part of the tubular member 12. A drive shaft 10 manufactured in this manner is also described.

This invention relates to a drive shaft, and in particular to a drive shaft of composite material form.

Composite materials, for example in the form of resin impregnated wound fibre form, are in widespread use in a number of applications as they are of good strength and low weight. As a result, in applications in which component weights are of importance, the use of composite materials is of significant benefit. One such application is in the aerospace industry in which the ability to make weight savings can lead to improved fuel efficiency of the aircraft. Furthermore, in some applications in which parts are to be rotated at high speed, such as in drive shafts, it is desired to use low weight materials.

Where drive shafts are manufactured from composite materials, there is usually a need for fittings to be secured to the ends of the composite material part of the drive shaft to allow the drive shaft to be coupled to other components. A number of arrangements are known in which the end fittings are push fitted over an end of the drive shaft. However, there are situations where is may be preferred for the end fittings to be arranged to contact an inner surface of the drive shaft rather than being fitted over an exterior surface of the drive shaft. By way of example, such internal attachment of the end fittings may allow the dimensions of the relatively heavy end fitting to be reduced, which may in turn lead to further weight savings.

US2008/0119296 describes a composite material structural member including end fittings. The member is fabricated by laying up layers of uncured resin impregnated sheets over a neck of the end fitting and over a mandrel to form a tubular shaft. After curing of the resin, a ferrule is fitted around the neck of the end fitting and the adjacent composite material.

It is desirable, therefore, to provide an arrangement whereby an end fitting can be attached to a composite material drive shaft in which the end fitting bears against an interior surface of the drive shaft and in which reliable drive transmission between the composite material of the drive shaft and end fitting is achieved. It is an object of the invention to provide an arrangement in which this is achieved.

According to the present invention there is provided a method of assembly of a shaft comprising providing a tubular member of composite material form, fitting a collar to the tubular member, and subsequently press fitting a part of an end fitting to the tubular member such that the tubular member is compressed between the collar and the said part of the end fitting.

The collar is conveniently of a composite material. However, this need not be the case and it could be of other materials, for example it may be of a metallic material. It may be fitted to the exterior of the tubular member, in which case fitting of the collar to the tubular member may serve to radially inwardly compress the material of the tubular member. However, this need not always be the case and it may be fitted to the interior of the tubular member, radially outwardly expanding the tubular member.

The shaft may comprise a rotary drive shaft.

Preferably, prior to the fitting of the collar, a machining step is undertaken on the surface of the tubular member to be engaged by the end fitting, for example on the interior of the tubular member, to machine the surface to a predetermined profile. By way of example, the predetermined profile may be of cylindrical form, for example with a diameter that is slightly smaller than the outer diameter of the part of the end fitting that is to be introduced therein.

It will be appreciated that in such an arrangement, the application of the collar to the tubular member to inwardly compress the end part of the tubular member ensures that a good interference fit is subsequently achieved between the tubular member and the end fitting, forming a reliable connection therebetween. The part of the end fitting which is coupled to the tubular member may be of reduced diameter, and so requires the presence of a reduced quantity of material, and so weight and cost savings may be achieved through the use of the invention.

Prior to the fitting of the collar to the end part of the tubular member, the surface of the tubular member to be engaged by the collar may be machined to adopt a predetermined profile. By way of example, it may be machined to adopt a substantially part conical, tapering form. Such an arrangement is advantageous in that it aids introduction of the collar onto the end part of the tubular member and ensures that the act of pushing the collar further onto the tubular member achieves inward compression of the end part of the tubular member.

The action of fitting the collar to the tubular member preferably results in inward compression of the end part of the tubular member by a distance of less that 2 mm. In many applications, the compression will result in inward deflection of the end part of the tubular member by a distance of less than 1 mm. Whilst these inward deflections are small, they are usually sufficient to ensure that the engagement between the tubular component and the end fitting is a good, reliable interference fit.

The said part of the end fitting is preferably of non-circular shape. By way of example, the surface thereof which, in use, engages the tubular member may be shaped to include teeth, splines or other angularly spaced projections.

In such an arrangement, the collar serves to prevent or resist radial expansion or contraction of the end part of the tubular member (depending upon whether fitted externally or internally) as would be required for relative angular movement to occur between the tubular member and the end fitting. The presence of the collar thus enhances the torque transmitting properties of the assembly.

The tubular member preferably takes the form of a resin impregnated wound fibre component element. By way of example, the fibres may comprise carbon fibres. However, it will be appreciated that other materials may be used without departing from the scope of the invention. Similarly, the collar preferably comprises a wound fibre reinforced resin composite material. By way of example, it may have a fibre winding angle in the region of 70-80°.

End fittings may be applied to both ends of the fibre component in this manner, if desired.

The invention further relates to a drive shaft comprising a tubular member of composite material form, a collar of composite material form fitted to an exterior of an end part of the tubular member to inwardly compress the end part of the tubular member, and an end fitting, part of which is press fitted into the interior of the end part of the tubular member.

The invention will further be described, by way of example, with reference to the accompanying drawings, in which:

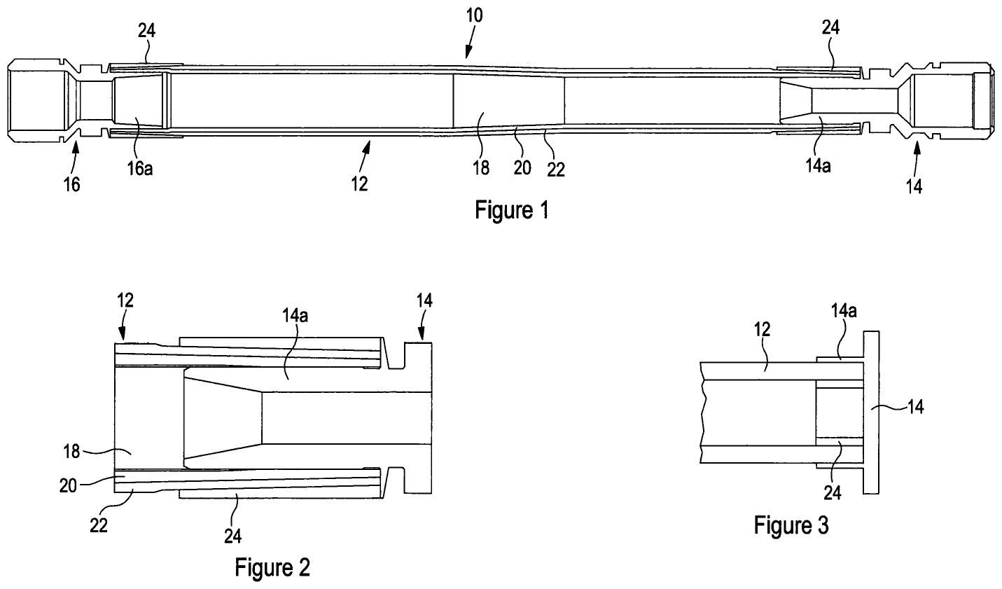

FIG. 1 is a view illustrating, in diagrammatic form, a drive shaft in accordance with an embodiment of the invention;

FIG. 2 is a view to an enlarged scale illustrating part of the drive shaft of FIG. 1; and

FIG. 3 is a diagrammatic view illustrating an alternative embodiment of the invention.

Referring firstly to FIGS. 1 and 2 of the accompanying drawings, a drive shaft 10 is illustrated. The drive shaft 10 is intended for use in the aerospace industry, being located, in use, within an aircraft engine and transmitting torque between parts thereof. As such, the drive shaft 10 must be capable of withstanding very high rotary speeds. As a consequence, it is desirable for the drive shaft to be of high strength and low weight. In order to achieve this, the drive shaft 10 is primarily of composite material form, comprising a tubular member 12 of multi-layered, composite material form to the ends of which are fitted end fittings 14, 16. The end fittings 14, 16 are of metallic form, and are machined to adopt a required shape or profile to allow cooperation with other parts of the engine, for example being provided with external teeth, splines or the like to allow coupling of the drive shaft to such engine parts.

The tubular member 12 is, as mentioned hereinbefore, of multi-layered form. In the arrangement shown, it comprises an inner skin 18, an intermediate layer 20 and an outer layer 22. Each of the layers 18, 20, 22 is formed by winding a suitable fibre material, for example of carbon fibre form, onto a mandrel. The fibres may pass through a resin bath prior to winding to apply a resin material to the fibres such that the material wound onto the mandrel comprises a resin impregnated fibre material, and once the winding of the fibres onto the mandrel has been completed, the resin material may be allowed to cure, for example by undertaking appropriate heating steps. It will be appreciated that this represents just one technique that may be used in the manufacture of the tubular member and that other techniques may be used if desired. By way of example, the fibres may be wound onto the mandrel without first applying a resin thereto, and subsequently a resin material may be applied to the fibres. Clearly, any suitable fabrication technique may be used in the manufacture of the tubular member without departing from the scope of the invention.

The different layers 18, 20, 22 are, in this embodiment, wound with different fibre winding angles to impart desired characteristics into the tubular member 12, for example to achieve required torque transmission characteristics, to achieve a required level of stiffness to the tubular member, and the like. Not only are the winding angles selected to ensure that the required characteristics are achieved, but also other parameters may be controlled, for example the thicknesses of the various layers, the winding densities thereof, etc, may be controlled as required. The tubular member 12 may be of uniform form throughout its length. However, this need not always be the case and in the arrangement illustrated the tubular member 12 is of relatively large diameter to one end and of smaller diameter to the opposite end, a tapering region being provided part way along the tubular member 12. The thicknesses of the various layers 18, 20, 22 need not be uniform along the length of the tubular member 12, and as shown the intermediate and outer layers 20, 22 are of greater thicknesses in the smaller diameter part of the tubular member 12, but this need not always be the case.

At the ends of the tubular member 12, the part of the mandrel over which the tubular member 12 is wound during the manufacture thereof is of tapering form with the result that the layers 18, 20, 22 taper inwardly at these locations. After manufacture of the tubular member 12, the inner surface of the tubular member 12 is machined to be of substantially cylindrical form, having a diameter that is slightly smaller than the diameter of the parts 14a, 16a of the end fittings 14, 16 to be fitted thereto. By forming the tubular member 12 in this manner, it will be appreciated that a number of windings or layers of the fibres located within the intermediate layer 20 will be exposed as a result of the machining, and so contact between the parts 14a, 16a and more of the windings or layers of the fibre forming the intermediate layer 20 may be attained, in use, and so torque transmission between the end fittings 14, 16 and the tubular member 12 may be enhanced.

The outer surfaces of the end parts of the tubular member 12 are machined to take a tapering, part conical form.

As illustrated, a collar 24 is fitted onto each end part of the tubular member 12. Each collar 24 is of wound fibre reinforced composite material form, manufactured separately from the formation of the tubular member 12. The inner surface of each collar 24 is of tapering form, having a taper angle that substantially matches that of the end part of the tubular member 12 to which it is to be fitted. The primary function of the collar 24 is to achieve compression of the end part of the tubular member 12, not to transmit torque, and so the fibre winding angle will be selected accordingly. By way of example, the winding angle may be as high as 70-80°, whereas the winding angles of the layers 18, 20, 22 will typically be considerably less than this. Such an arrangement is advantageous in that the collar 24 may be of relatively low weight and good strength.

During assembly, after machining of the inner and outer surfaces of the tubular member 12, the collars 24 are fitted thereto. The application or fitting of the collars 24 to the ends of the tubular member 12 causes the end parts of the tubular member 12 to be compressed inwardly by a small amount. Typically, the inward compression or deflection of the end parts of the tubular member 12 will be less than 2 mm, usually less than 1 mm, but it will be appreciated that the level of deflection will depend upon the application in which the invention is to be employed and upon the overall dimensions of the tubular member 12. By way of example, where the tubular member 12 is of relatively large diameter then it would be expected that the application of the collar thereto may be used to achieve a greater level of inward deflection than occurs where the tubular member 12 is of relatively small diameter.

After fitting of the collars 24 to the tubular member 12, the end fittings 14, 16 are attached to the tubular member 12 by forcing the parts 14a, 16a thereof into the interior of the end part of the tubular member 12. The action of forcing the end parts 14a, 16a into the tubular member 12 forces the end parts of the tubular member 12 to be restored to substantially their shapes prior to the fitting of the collars 24 thereto, and the presence of the collars 24 to the exterior of the tubular member 12 ensures that the end parts of the tubular member 12 are compressed firmly against the parts 14a, 16a of the end fittings 14, 16 ensuring that a reliable interference fit is maintained between the tubular member 12 and the end fittings 14, 16 able to transmit the loads therebetween that are applied in normal use.

The end parts 14a, 16a are conveniently of non-circular cross-sectional profile. By way of example, they may be of toothed or splined form or include other angularly spaced projections. In such an arrangement, press fitting of the end parts 14a, 16a into the end of the tubular member 12 results in some deformation of the tubular member 12 to accommodate the splines or the like. Once assembled, relative angular movement between the tubular member 12 and the end fittings 14, 16 requires some radial expansion of the tubular member 12 to occur. As such movement is resisted or prevented by the collar 24, it will be appreciated that the drive shaft is of good torque transmitting form, the manner in which the end fittings 14, 16 are secured to the tubular member 12 resisting relative angular movement therebetween.

Although in the arrangement described hereinbefore the collar 24 is located externally of the tubular member 12, and the end fittings 14, 16 project into the interior of the tubular member 12, this need not be the case and FIG. 3 illustrates an alternative arrangement in which the collar 24 is inserted into the interior of the tubular member 12, and the parts 14a, 16a of the end fittings 14, 16 extend around the exterior of the tubular member 12. Other than as described herein, the arrangement of FIG. 3 is of substantially the same form as that of FIGS. 1 and 2, and the same advantages as described hereinbefore apply.

It will be appreciated that through the use of the invention, a drive shaft is provided of composite material form and in which the connections between the composite material part of the drive shaft and the end fittings are interior connections having the benefits set out hereinbefore.

Whilst in the arrangement described hereinbefore the methodology of the invention is used to apply end fittings to both ends of the drive shaft, it will be appreciated that different techniques may be employed at the different ends of the shaft if desired.

Whilst a specific embodiment of the invention is described hereinbefore, it will be appreciated that a wide range of modifications and alterations may be made to the arrangement described hereinbefore without departing from the scope of the invention as defined by the appended claims.

1. A method of assembly of a shaft comprising providing a tubular member of composite material form, fitting a collar to the tubular member, and subsequently press fitting a part of an end fitting to the tubular member such that the tubular member is compressed between the collar and the said part of the end fitting.

2. A method according to claim 1, wherein the collar is of a composite material.

3. A method according to claim 1, wherein the collar is of a metallic material.

4. A method according to claim 1, wherein the collar is fitted to the exterior of the tubular member, fitting of the collar to the tubular member serving to radially inwardly compress the material of the tubular member.

5. A method according to claim 1, wherein the collar is fitted to the interior of the tubular member, radially outwardly expanding the tubular member.

6. A method according to claim 1, wherein the shaft comprises a rotary drive shaft.

7. A method according to claim 1, wherein the said part of the end fitting is of non-circular shape.

8. A method according to claim 7, wherein the surface of the said part of the end fitting which, in use, engages the tubular member is shaped to include teeth, splines or other angularly spaced projections.

9. A method according to claim 1, wherein prior to the fitting of the collar, a machining step is undertaken on the tubular member to machine the surface of the tubular member to a predetermined profile.

10. A method according to claim 9, wherein the predetermined profile is of cylindrical form with an internal diameter that is slightly smaller than the outer diameter of the part of the end fitting that is to be introduced therein.

11. A method according to claim 1, wherein prior to the fitting of the collar to the end part of the tubular member, the surface of the tubular member to be engaged by the collar is machined to adopt a predetermined profile.

12. A method according to claim 11, wherein the exterior surface is machined to adopt a substantially part conical, tapering form.

13. A method according to claim 1, wherein the action of fitting the collar to the tubular member results in inward or outward deflection of the end part of the tubular member by a distance of less that 2 mm.

14. A method according to claim 13, wherein the inward or outward deflection of the end part of the tubular member is less than 1 mm.

15. A method according to claim 1, wherein the tubular member takes the form of a resin impregnated wound fibre component element.

16. A method according to claim 15, where the fibres of the element comprise carbon fibres.

17. A method according to claim 1, wherein the collar comprises a wound fibre reinforced resin composite material.

18. A method according to claim 17, wherein the collar has a fibre winding angle in the region of 70-80°.

19. A drive shaft comprising a tubular member of composite material form, a collar of composite material form fitted to an exterior of an end part of the tubular member to inwardly compress the end part of the tubular member, and an end fitting, part of which is press fitted into the interior of the end part of the tubular member.
